(19) United States
(12) Patent Application Publication
(10) Pub. No.: US 2003/0022675 A1
(43) Pub. Date: Jan. 30, 2003

(54) Methods and apparatus for determining the position of a transmitter and a mobile communications device

(75) Inventor: Iwo-Martin Mergler, Southampton (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/197,665

(22) Filed: Jul. 17, 2002

(30) Foreign Application Priority Data
Jul. 24, 2001 (GB) 0117951.4

(51) Int. Cl. H04Q 7/20

(52) U.S. Cl. 455/456; 455/422

(57) ABSTRACT

A method of determining the position of a transmitter (BS1) located in the vicinity of a mobile communications device (MS1) which is able to determine its position is disclosed. The method comprising the steps of: (i) moving the mobile communications device (MS1) to a plurality of reference locations (pn); (ii) determining the position of the mobile communications device (MS1) and the range from the mobile communications device (MS1) to the transmitter (BS1) at each reference location (pn); and (iii) determining the position of the transmitter (BS1) using the positions and corresponding ranges determined in step (ii). Also disclosed is a method of determining the position of a mobile communications device (MS1) which utilizes the above method.

### FIELD OF INVENTION

This invention relates to a method and corresponding apparatus for determining the position of a transmitter and to a related method and corresponding apparatus for determining the position of a mobile communications device.

### BACKGROUND TO INVENTION

In order to provide a GPS position fix, a typical GPS receiver needs to receive at least 4 GPS signals and thus must have at least 4 GPS satellites in view. Unfortunately, however, in areas where there is significant foliage or in an urban canyon, there can often be less than 4 satellites in view at any one time. Furthermore, when the GPS receiver is moving, e.g. when in the possession of a user travelling in a car, the number satellites in view and which satellites are in view may change rapidly.

It is known from at least related U.S. Pat. Nos. 5,982,324, 6,236,359 and 6,249,245 to provide a mobile cellular telephone incorporating a GPS receiver and to use ranging measurements between the mobile telephone and a cellular network base station to which it is registered to supplement pseudoranges obtained by the GPS receiver for the purposes of obtaining a position fix when there are less than 4 GPS satellites in view. Such an arrangement requires that the position of the base station be known and where the position of the mobile telephone is determined at telephone, that the position of the base station be transmitted to the telephone. However, if the position of a base station is unknown or, where the position is determined in the telephone, the position of the base station is not transmitted to the mobile telephone, such ranging between the base station and the telephone is worthless.

### OBJECT OF INVENTION

It is therefore an object of the present invention to provide a method and corresponding apparatus for determining the position of a transmitter located in the vicinity of a mobile communications device, and to further provide a related method and corresponding apparatus for determining the position of the mobile communication device.

### SUMMARY OF INVENTION

According to a first aspect of the present invention, a method of determining the position of a transmitter is provided where the transmitter is located in the vicinity of a mobile communications device which is able to determine its position. The method comprising the steps of (i) moving the mobile communications device to a plurality of reference locations; (ii) determining the position of the mobile communications device and the range from the mobile communications device to the transmitter at each reference location; and (iii) determining the position of the transmitter using the positions and corresponding ranges determined in step (ii).

For the avoidance of doubt, “reference location” is not intended to convey the meaning that the location is somehow fixed or predetermined, but rather that once its position in step (ii) is determined, it is a reference location with respect to which the position of the transmitter is determined in step (iii).

Such a method enables the location of a transmitter to be determine which may then be used a reference to subsequently determine a further location of the mobile communications device. Thus, according to a second aspect of the present invention, a method of determining the position of a mobile communications device is provided comprising the steps of (a) determining the position of at least one transmitter located in the vicinity of the mobile communications device by a method according to the first aspect of the present invention; (b) determining the range from the mobile communications device to the or each transmitter; and (c) determining the position of the mobile communications device using the position of the or each transmitter determined in step (a) and the or each range determined in step (b).

The positions of the mobile communications device in step (ii) may be determined using a GPS receiver and where this is the case, the position of the mobile communications device may be determined in step (c) using a combination of pseudoranges obtained using the GPS receiver, the position of the or each transmitter determined in step (a) and the or each range determined in step (b). This is convenient where, during step (c), the GPS receiver is not able to obtain an unambiguous position fix by itself.

Also provided in accordance with the present invention is a mobile communications device according to any of claims 9 to 13.

### DESCRIPTION OF DRAWINGS

Apparatus employing a method of positioning according to the present invention will now be described, by way of example only, with reference to the accompanying drawings in which:

FIG. 1 shows the geographic layout of a cellular telephone network;

FIG. 2 shows the configuration of mobile cellular telephone MS1 in greater detail;

FIG. 3 illustrates ranging between fixed base station BS1 and mobile telephone MS1 at locations p1, p2, p3 and p4; and

FIG. 4 illustrates ranging between mobile telephone MS1 and base stations BS1, BS2, BS3 and BS4.

### DETAILED DESCRIPTION

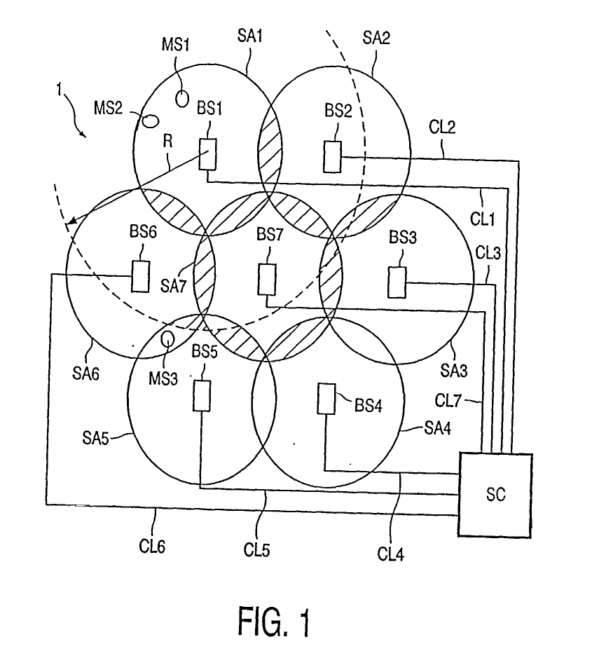

The geographical layout of a conventional GSM cellular telephone network 1 is shown schematically in FIG. 1. The network comprises a plurality of base stations BS of which seven, BS1 to BS7, are shown, situated at respective, mutually spaced geographic locations. Each of these base stations comprises the entirety of a radio transmitter and receiver operated by a trunking system controller at any one site or service area. The respective service areas SA1 to SA7 of these base stations overlap, as shown by the cross hatching, to collectively cover the whole region shown. The system may furthermore comprise a system controller SC provided with a two-way communication link, CL1 to CL7 respectively, to each base station BS1 to BS7. Each of these communication links may be, for example, a dedicated land-line. The system controller SC may, furthermore, be connected to a the public switched telephone network (PSTN) to enable communication to take place between a mobile cellular telephone MS1 and a subscriber to that network. A plurality of mobile telephones MS are provided of which three, MS1, MS2 and MS3 are shown, each being able to roam freely throughout the whole region, and indeed outside it.

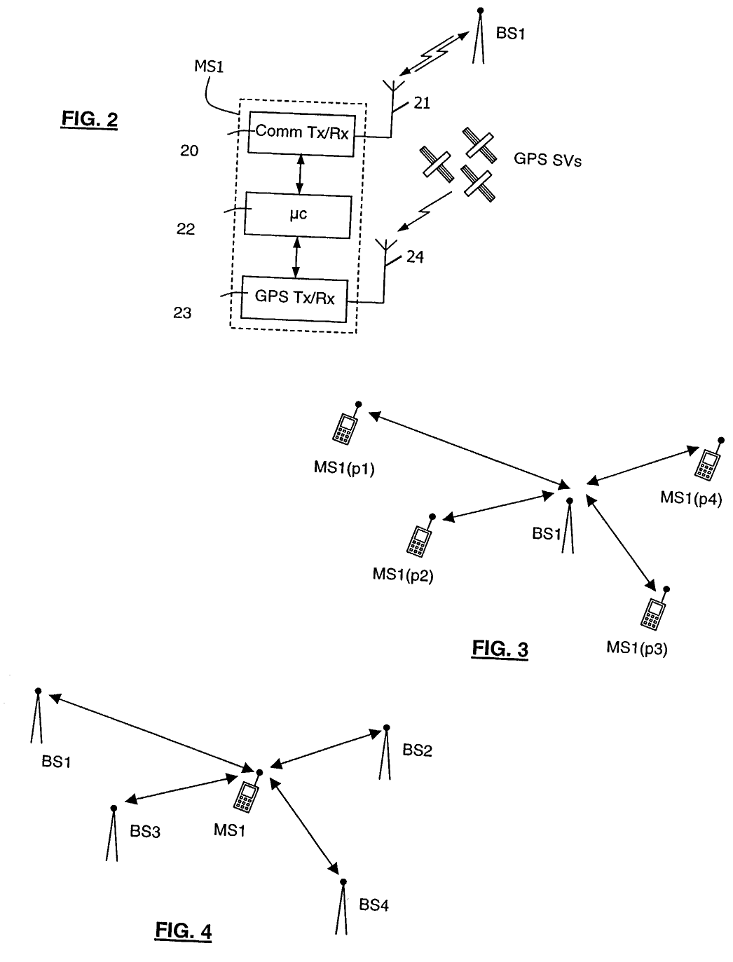

FIG. 2 shows in greater detail the configuration of mobile telephone MS1 which comprises a communications transmitter and receiver (Comm Tx/Rx) 20 connected to a communications antenna 21 and controlled by a microprocessor (μc) 22 for communication with the base station BS1 with which it is registered. The design and manufacturing of such telephones for two-way communication within a cellular telephone network are well known and, as such, those parts which do not form part of the present invention will not be elaborated upon here further.

In addition to the conventional components of a mobile telephone, telephone MS1 further comprises a GPS receiver (GPS Rx) 23 connected to a GPS antenna 24 and controlled by the microprocessor (μc) 22 for receiving GPS spread spectrum signals transmitted from orbiting GPS satellites. When operative, the GPS receiver 24 may receive NAVSTAR SPS GPS signal through the GPS antenna and pre-process them, typically by passive bandpass filtering in order to minimize out-of-band RF interference, preamplification, down conversion to an intermediate frequency (IF) and analog to digital conversion. The resultant, digitised IF signal remains modulated, still containing all the information from the available satellites, and is fed into a memory (not shown) of the microprocessor. The GPS signals may then be are acquired and tracked in any of several digital receiver channels, typically up to 12, for the purpose of obtaining pseudorange information from which the position of the mobile telephone can be determined using conventional navigation algorithms. Such methods for GPS signal acquisition and tracking are well known, for example, see chapter 4 (GPS satellite signal characteristics) & chapter 5 (GPS satellite signal acquisition and tracking) of GPS Principles and Applications (Editor, Kaplan) ISBN 0-89006-793-7 Artech House. The general purpose microprocessor 22 shown controls both base station communication and GPS processing, however, it will be appreciated alternative processing architectures may be employed to achieve the same result, for example, an architecture employing separate communication and GPS ICs.

### DETERMINING THE LOCATION OF A BASE STATION

Referring to FIG. 3, base station BS1 is located at unknown co-ordinate (X_{bs1}, Y_{bs1}, Z_{bs1} ). Mobile telephone MS1 comprises a GPS receiver and is able to obtain position fixes using the GPS receiver at n different locations (pn) having co-ordinates (Xₚₙ, Yₚₙ, Zₚₙ). At these locations, mobile telephone MS1 is able to communicate with base station BS1 with which it is registered in such a manner as to be able to obtain range measurements (r_{pn-bS1}) to base station BS1. Having obtained position fixes and corresponding range measurements at 3 different locations, the location of base station BS1 can be determined by resolving the following simultaneous equations:

(r_{p1-bs1})²=(x_{bs1}-xₚ₁)²+(y_{bs1}-yₚ₁)²+(z_{bs1}-zₚ₁)²

(r_{p2-bs1})²=(x_{bs1}-xₚ₂)²+(y_{bs1}-yₚ₂)²+(z_{bs1}-zₚ₂)²

(r_{p3-bs1})²=(x_{bs1}-xₚ₃)²+(y_{bs1}-yₚ₃)²+(z_{bs1}-zₚ₃)²

Whilst the above formulation requires 3 position fixes and corresponding range measurements, it is possible to make an assumption that the altitude of base station BS1 and positions p1 and p2 are the same in which case it is only 2 position fixes and corresponding range measurements taken at locations p1 and p2 are required to determine the position of base station BS1. Similarly, it is possible to take 4 or more position fixes and corresponding range measurements at different locations to provide an over-determined set of equations which can be solved using a best-fit type method. Such a method is more reliable if spurious position fixes and range measurements are likely.

### DETERMINING THE LOCATION OF A TRANSMITTER

Using the method above, the position of any cellular telephone network base station may be determined from which subsequent ranging measurements can be used to determine the position of the mobile unit.

Referring to FIG. 4, mobile telephone MS1 is presently located at unknown co-ordinate (xₘₛ, yₘₛ, zₘₛ) having previously determined the position of nearby base stations BS1, BS2 and BS3 having co-ordinates (x_{bsn}, y_{bsn}, z_{bsn}). From these base stations, mobile telephone MS1 is able to communicate with the base stations in such a manner as to be able to obtain range measurements (r_{ms-bsn}) to these base stations and thereby determine the location of mobile telephone MS1. For example, by resolving the following simultaneous equations:

(r_{p1-bs1})²=(x_{bs1}-xₘₛ)²+(y_{bs1}-yₘₛ)²+(z_{bs1}-zₘₛ)²

(r_{p2-bs1})²=(x_{bs2}-xₘₛ)²+(y_{bs2}-yₘₛ)²+(z_{bs2}-zₘₛ)²

(r_{p3-bs1})²=(x_{bs3}-xₘₛ)²+(y_{bs3}-yₘₛ)²+(z_{bs3}-zₘₛ)²

Again, assumptions made be made to reduce the number of determinations positions of the base stations and range measurements that need to be made. Also, more determinations may be made to provide an over-determined set of equations which can be solved using a best-fit method. As a further alternative, conventional time difference of arrival (TDOA) positioning techniques may be used to determine the position of mobile unit MS1.

The above example uses ranging to base stations at previously unknown locations as a complete substitute for GPS positioning, however, this need not be the case. For example, when the GPS receiver of MS1 is able to see 4 GPS satellites at three separate locations, the position of a single basestation, conveniently that with which mobile telephone MS1 is registered, may be determined. Then, in the event that one of the GPS satellite signals is lost, for example when entering an urban canyon, ranging to the single basestation can be used to supplement the pseudoranges derived from the remaining GPS signals in view to obtain a new position fix.

As an alternative to a GPS receiver, conventional terrestrial based positioning system may be used to provide the locations pn which are used to determine the position of the base stations. For example, a mobile telephone MS1 may be deployed in a network of short range information beacons which broadcast their position. When in range of a particular beacon the broadcasted position can be used as an estimate of the position pn of mobile telephone MS1.

Whilst the invention has been described with the primary commercial application of positioning mobile telephones, it will be appreciated other devices including dedicated positioning units could employ such method of positioning.

From a reading of the present disclosure, other modifications will be apparent to the skilled person and may involve other features which are already known in the design, manufacture and use of both GPS receivers and mobile communications devices, and component parts thereof, and which may be used instead of or in addition to features already described herein.

1. A method of determining the position of a transmitter located in the vicinity of a mobile communications device which is able to determine its position, the method comprising the steps of:
(i) moving the mobile communications device to a plurality of reference locations;
(ii) determining the position of the mobile communications device and the range from the mobile communications device to the transmitter at each reference location; and
(iii) determining the position of the transmitter using the positions and corresponding ranges determined in step (ii).

2. A method according to claim 1 wherein the positions of the mobile communications device are determined in step (ii) using a GPS receiver.

3. A method according to claim 1 wherein the transmitter is a cellular telephone network base station and the mobile communications device is a mobile cellular telephone registered with that base station.

4. A method of determining the position of a mobile communications device comprising the steps of:
(a) determining the position of at least one transmitter located in the vicinity of the mobile communications device, each by a method comprising the steps of:
(i) moving the mobile communications device to a plurality of reference locations;
(ii) determining the position of the mobile communications device and the range from the mobile communications device to a transmitter at each reference location; and
(iii) determining the position of that transmitter using the positions of the mobile communications device and the corresponding ranges determined in step (ii).
(b) determining the range from the mobile communications device to the or each transmitter; and
(c) determining a further position of the mobile communications device using the position of the or each transmitter determined in step
(a) and the or each range determined in step (b).

5. A method according to claim 4 wherein the positions of the mobile communications device are determined in step (a)(ii) using a GPS receiver.

6. A method according to claim 5 wherein the position of the mobile communications device is determined in step (c) using a combination of pseudoranges obtained using the GPS receiver, the position of the or each transmitter determined in step (a) and the or each range determined in step (b).

7. A method according to claim 6 wherein the position of the mobile communications device in step (c) is determined when the GPS receiver is not able to obtain an unambiguous position fix by itself.

8. A method according to claim 4 to 7 wherein at least one transmitter is a cellular telephone network base station and the mobile communications device is a mobile telephone registered with that base station.

9. A mobile communications device comprising positioning means for determining positions of the mobile communications device; ranging means for determining ranges from the mobile communications device to a transmitter located in the vicinity; and processing means configured to determine the position of the transmitter using positions of the mobile communications device determined by the positioning means and corresponding ranges determined by the ranging means.

10. A device according to claim 9 wherein the positioning means comprises a GPS receiver.

11. A device according to claim 9 wherein the processing means is further configured to determine a further position of the mobile communications device using the position of at least one transmitter determined by the processing means and a corresponding range or ranges determined by the ranging means.

12. A device according to claim 11 wherein the positioning means comprises a GPS receiver and the processing means is configured to determine the further position of the mobile communications device using a combination of pseudoranges obtained by the GPS receiver, the position of at least one transmitter determined by the processing means and a corresponding range or ranges determined by the ranging means.

13. A device according to claim 9 in the form of a mobile cellular telephone wherein the ranging means is able to determining ranges to a transmitter in the form of a cellular telephone network base station to which the mobile telephone is registered.
